(19) United States
(12) Patent Application Publication
(10) Pub. No.: US 2006/0283844 A1
(43) Pub. Date: Dec. 21, 2006

(54) Laminated cookware

(75) Inventor: Stanley Kin Sui Cheng, Vallejo, CA (US)

Correspondence Address: MEYER CORPORATION, U.S.;ATTN: EDWARD S. SHERMAN, ESQ., ONE MEYER PLAZA, VALLEJO, CA, 94590, US

(73) Assignee: Meyer Intellectual Properties Ltd.

(21) Appl. No.: 11/157,352

(22) Filed: Jun. 21, 2005

(51) Int. Cl. B23K 26/28

(52) U.S. Cl. 219/121.64

(57) ABSTRACT

A process to form laminated cookware vessels starts with individual metal sheets, which are first formed into individual fluid containing vessels. The fluid containing vessels are nested together and bonded in a multi-step process that deploys laser welding to form the vessels rim. The process provides great flexibility in combining different materials and varying the laminated construction of the bottom as compared to the surrounding sidewall of the cookware vessel.

### CROSS REFERENCE TO RELATED APPLICATIONS

None

### BACKGROUND OF INVENTION

The present invention relates to an improved process for fabricating laminated cookware articles.

Laminated cookware articles are well known. They typically deploy copper and/or aluminum as one or more core layers, with surrounding layers to form the exposed interior and/or exterior surface of the cookware.

Among other benefits, the copper and/or aluminum core layers enhances the thermal performance of the cookware; enabling both a faster heating of the foodstuffs and a more uniform temperature distribution. Outer layers of the laminate, that surrounds the copper and/or aluminum core, can provide an exterior surface that is easier to clean or maintain a particular desired appearance in the kitchen.

Such laminated articles of cookware are fabricated starting with pre-laminated sheet stock. Methods of making sheet stock suitable for eventually forming cookware are disclosed in U.S. Pat. No. 6,427,904 to Groll, titled “Bonding of Dissimilar Metals”, as well as U.S. Pat. No. 6,109,504, also to Groll, and titled “Copper Core Cooking Griddle and Method of Making Same”. The '504 teaches the desirability of forming a sheet stock laminate of stainless steel/copper/stainless steel useful for fabricating cookware via the sequential reduction of thickness by repeated hot roll bonding steps. The preferred composition is a diffusion bonded composite of 304L grade stainless steel outer layers with an inner core of high purity C-102 grade copper. However, explosion bonding is initially used to laminate the three layers.

The cookware is then fabricated from the laminated sheet stock by first cutting or trimming the sheet stock into round shape. The round trimmed pieces are then deformed or drawn in a die to form a fluid containing cookware vessel. However, as the laminating process itself is cumbersome, the laminated stock material is expensive, adding to the cost of the final product. Moreover, a large portion of this expensive material is lost as waste trim. The trimmed material being laminated it also difficult to recycle.

Accordingly, it would be desirable and is a first object of the invention to provide an alternative process to forming laminated cookware that does not require the use of pre-laminated sheet stock.

### SUMMARY OF INVENTION

In the present invention, the first object of providing a cost effective method of forming clad cookware is achieved by providing a first substantially planar sheet comprising at least one layer of a first metal, then providing a second substantially planar sheet comprising at least one layer of a second metal, drawing the first planar sheet to form a first preform that is a fluid containing vessel, drawing the second planar sheet to form a second preform that is a fluid containing vessel that nests within the first preform (such that each fluid containing vessel has a bottom surface and surrounding sidewalls extending upward therefrom), nesting the second perform within the first perform to form a subassembly, bonding the interface between the first and second perform to form a first bonded preform. The first bonded preform is laser welded to fully bond the materials of the first and second preforms along an annulus that circumscribes the surrounding sidewalls at the portion thereof intended to form the rim of the article of cookware. Generally, the article of cookware is trimmed at this location after laser welding.

The above process can be extended to include the bonding and laser welding of a third preform formed from a third sheet of metal, thus encapsulating laminate of one metal layer between two other metal layers in the final clad structure.

The above and other objects, effects, features, and advantages of the present invention will become more apparent from the following description of the embodiments thereof taken in conjunction with the accompanying drawings.

### BRIEF DESCRIPTION OF DRAWINGS

FIG. 1 is a cross-sectional elevation of an article of cookware according to a first embodiment of the invention.

FIG. 2 is a schematic diagram illustrating the steps in the process used to fabricate the article of cookware of FIG. 1.

FIG. 3 is a cross-sectional elevation of an article of cookware according to a second embodiment of the invention.

FIG. 4 is a schematic diagram illustrating the steps in the process used to fabricate the article of cookware of FIG. 3.

FIG. 5 is a cross-sectional elevation of an article of cookware according to another embodiment of the invention.

### DETAILED DESCRIPTION

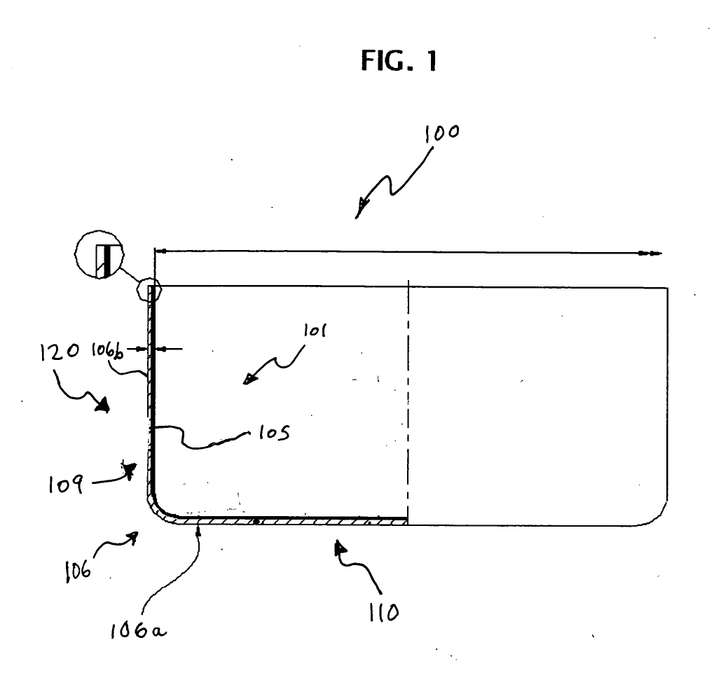

Referring to FIGS. 1 through 5, wherein like reference numerals refer to like components in the various views, there is illustrated therein a new and improved clad article of cookware, generally denominated 100 herein.

In accordance with the present invention, FIG. 1 illustrates a first embodiment of the invention in which an article of cookware 100 has a bottom cooking surface 110 surrounded by an upward extending sidewall 120 to form a fluid containing vessel. The article of cookware 100 generally also includes one or more sideward extending handles, which are not shown in the drawing. The sidewall 120 and bottom 110 have a laminated construction in which the entire inner cooking surface 101 is lined with a layer of stainless steel 105 that is in turn surrounded by an exterior layer 109 of copper cladding 106. A portion of the copper cladding 106a is about 1.5 mm thick at the bottom cooking surface 110, whereas another portion of the copper cladding 106b in the sidewall has a thickness that is preferably no more than about 90% of thickness at the bottom cooking surface, that is less than about 1.3 to 1.4 mm. The inner lining of stainless steel is preferably grade 304. The interior stainless steel lining 105 protects the interior surface of the copper from tarnishing with use, providing a surface that is easier to clean after cooking. The stainless steel layer 105 also strengthens the article of cookware 100 such that the copper layer 106 does not need to be thicker than about 1.5 mm, helping to reduce the cookware weight without a significant degradation in thermal responsiveness. The cookware weight is further reduced by making the sidewall portion 106b of copper layer 106 in the sidewall 112 thinner than the copper layer 106a in the bottom-cooking surface 110, which is required for thermal performance. Preferably, the copper layer 106a in the bottom surface 110 has a thickness of about 1.5 mm, whereas the portion of the copper layer 106b in the sidewall 120 has a thickness of about 1.2 mm. The stainless steel layer 105 that forms the interior surface 101 of the cooking vessel preferably has a constant thickness of about 0.6 mm, resulting in a total thickness of about 2.10 mm for the bottom cooking surface 110. In contrast, the sidewall 120 has a total thickness of about 1.8 mm. More generally, it is preferable that the copper in the sidewall is no more than about 80% of the thickness of the copper in the bottom of the pan

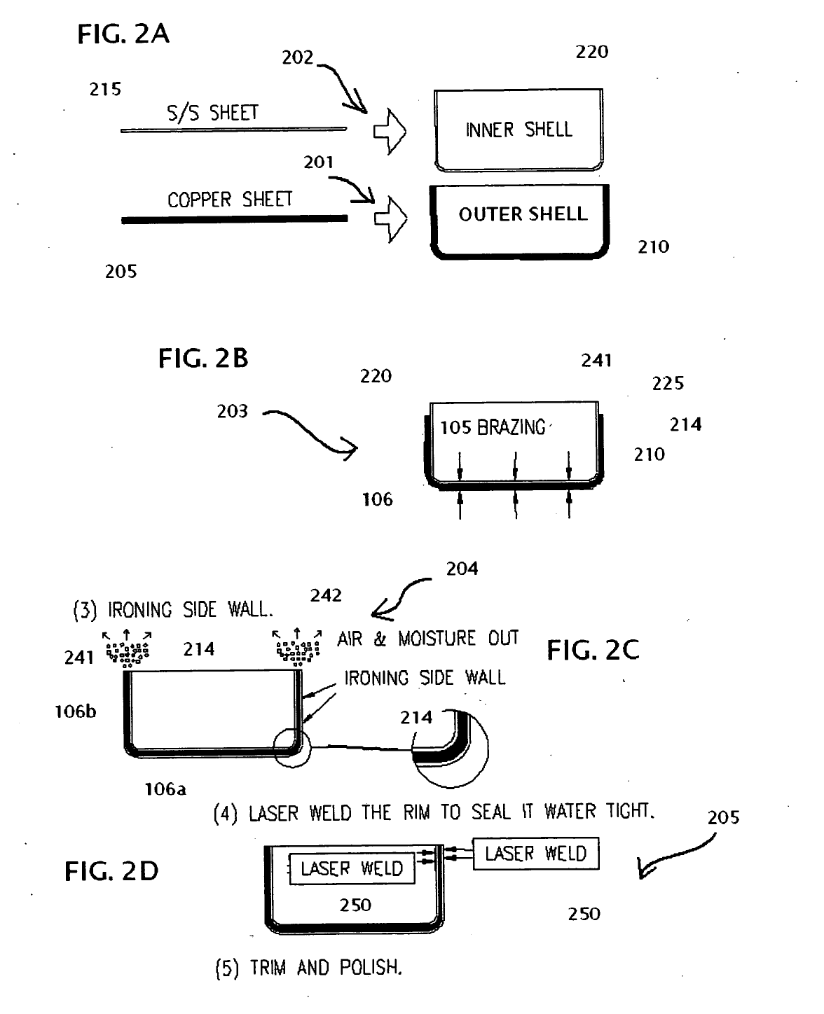

FIG. 2 illustrates another embodiment of the invention in which a novel sequence of steps is used to fabricate the article of cookware 100, shown in FIG. 1. The process described with respect to FIG. 2 has two advantages. First, it provides a cost savings compared to forming a cooking vessel by deforming a sheet of clad metal comprising a uniform layer of stainless steel bonded to a uniform layer of copper. Further, the process allows the copper exterior to be made thinner in the sidewall than in the bottom of the pan, where the extra thickness of the copper results in improved temperature uniformity across the bottom surface 110 during cooking. This construction reduces the weight of the pan, as compared to deploying a copper layer with a constant thickness of 1.5 mm The resulting cookware article is lighter and thus easier for the user or consumer to handle.

In step 201, shown in FIG. 2A, a substantially planar sheet of copper 205, or an alloy thereof, is drawn to form a fluid containing vessel or outer shell 210. In this embodiment, outer shell 210 will become the exterior of the completed cooking vessel 100.

In step 202, also shown in FIG. 2A, a substantially planar sheet of stainless steel, preferably grade 304 alloy, 215 is drawn to form a fluid containing liner or inner shell 220. However, to the extent that it is desirable to utilize the completed article of cookware with induction cooking, stainless steel grade 430 is preferred.

In step 203, shown in FIG. 2B, the inner shell 220 is nested within the outer shell 210, forming subassembly 225. A brazing compound is applied to at least one of the exterior of the inner shell 220 or the interior of the outer shell 210 prior to the nesting.

Also in step 203, to complete the brazing process, the temperature of the subassembly is raised to melt the brazing compounding, which upon cooling forms a metallurgical bond at interface 214, uniting the inner shell 220 and the outer shell 210. Pressure is applied to compress the inner and outer shells against each other at the common interface 214, facilitating the consolidation and flow of the liquid brazing compound. It should be appreciated that each of the shells 220 and 210 are drawn in steps 201 and 202 with sufficient dimension tolerances to facilitate complete insertion of the inner shell 220 in the inner shell 210. A slight gap is also provided to accommodate the solid brazing compound (as well as for the eventual wicking of the molten brazing compound or liquid flux) at the common interface, 214, of subassembly 230.

Shown schematically in FIG. 2C is step 204, an “ironing process” to reduce the thickness of the sidewall 120. “Ironing” is done by the continued deep drawing of subassembly 225 in a set of dies with the clearance between male and female die members that is smaller than the actual combined thicknesses of the sidewall 120. As the copper outer layer 106b, is much softer than stainless steel 105, only the thickness of the copper layer 106b is reduced. As it can be difficult in the brazing process of step 203 to fully reflow the liquid flux over the entire areas to be bonded in interface 214, air and moisture can be trapped within this gap. The “ironing process” has another advantage in that it gradually expels air and moisture trapped at the common interface 214. As the stainless steel layer 105 is not drawn the “ironing” 204, it will remain the same height as when formed in 202, defining rim 241. However, as the wall thickness of the copper layer 106b is reduced, the height of this wall will increase from that resulted from forming step 210.

While it is possible to initially form both the inner shell 220 and outer shell 210 with a predetermined difference in initial wall heights with the intention that they become uniform during the “ironing” process of step 204, it is preferable to trim the sidewall 120 to define the final rim height after the “ironing” process. This trimming step may utilize conventional mechanical cutting tools, water jet cutting, laser cutting and the like.

When the trimming step is performed after “ironing” it is more preferable to utilize laser welding to fully bond and thus tightly seal the inner shell 220 to the outer shells 210 at the intended rim position, shown schematically as step 205 in FIG. 2D. In step 205, the laser beam 250 is focused to heat the intended trim area Laser welding is well known in the art of metal fabrication. One of ordinary skill in this art can readily determine the optimum laser welding conditions appropriate to the thickness, absorption and heat capacity of the copper and stainless steel layers at the weld location by routine experimentation.

After trimming the article of cookware, it is preferably polished to achieve the desired aesthetic appearance. After the trimming and polishing steps in the fabrication process shown in FIG. 2A-2D, one or more handles are generally attached to sidewall 120.

Ironing is a preferred but not limiting embodiment, depending on the ease and integrity of the bond formed in the initial brazing process.

It should be appreciated that a multilayer laminated sheet of metal may be used to form one or more of the preforms that are nested inside each other and then bonded together. This may be desired when a particular pair of metal is more difficult to join by the inventive process, but a third metal is readily bonded by the inventive process after the corresponding preforms are nested together.

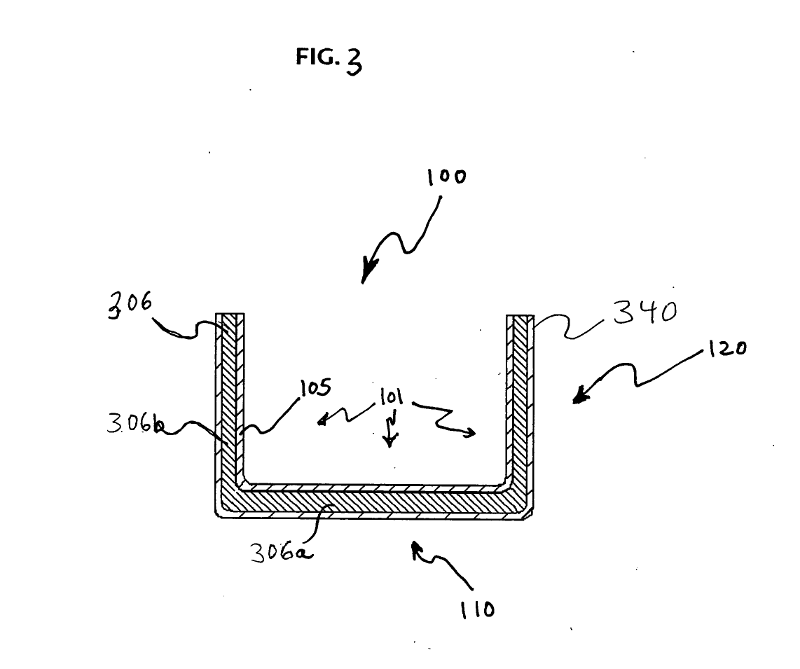

FIG. 3 illustrates another embodiment of the invention in which an article of cookware 100 has a bottom cooking surface 110 surrounded by an upward extending sidewall 120 to form a fluid containing vessel. The sidewall and bottom have a laminated construction in which the entire inner cooking surface 101 is lined with a layer of stainless steel 105. Stainless steel layer 105 is surrounded on the exterior surface by a layer of copper cladding 306. The copper cladding 306 is 1.5 mm thick in the bottom portion 306a, whereas the thickness in the sidewall portion 306b is about 1.2 mm thick. An outer stainless steel protective layer 340 surrounds the inner copper cladding 306. The inner and outer linings of stainless steel are preferably grade 304, and more preferably have a constant thickness of about 0.6 mm. As in the cookware article 100 of FIG. 1, this cooking vessel advantageously deploys thinner copper in the sidewalls 120 than is required in the bottom-cooking surface 110 to achieve a substantially uniform temperature, thus reducing the total weight of the cookware article.

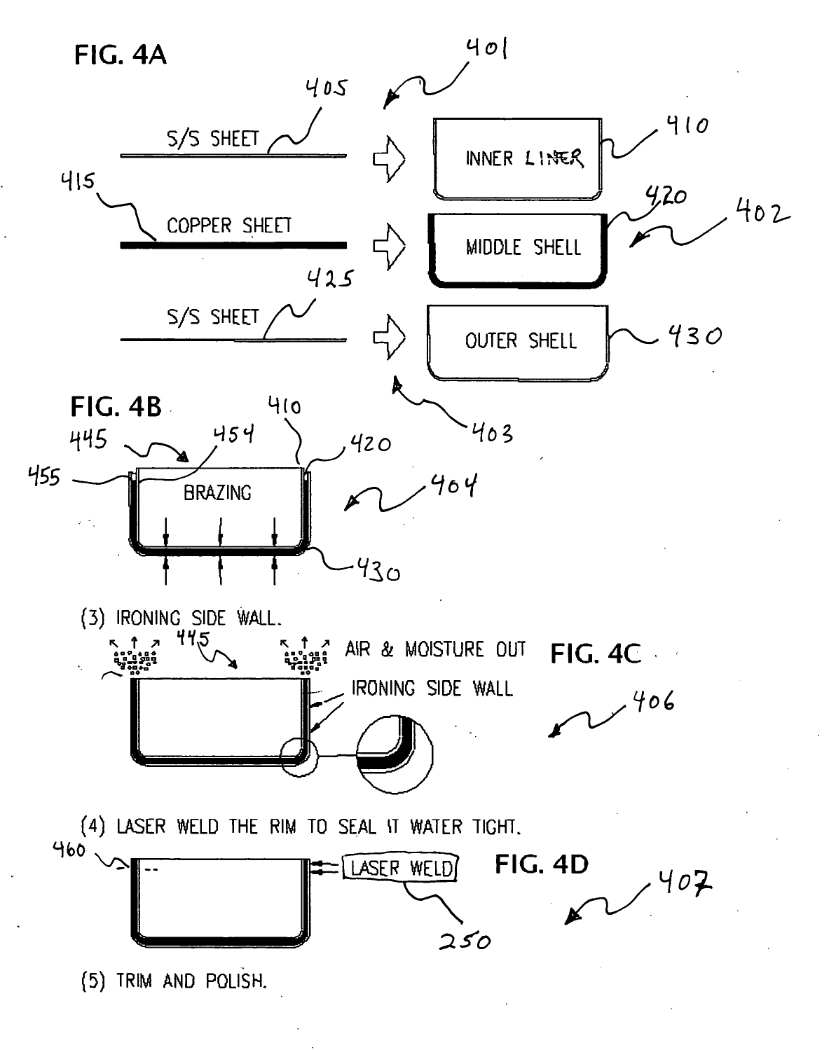

Further, the fabrication processes used to form cookware article 100 of FIG. 3, as illustrated in FIG. 4, has a lower manufacturing cost savings than constructing a comparable article of cookware starting from a triple ply clad sheet that comprise a stainless steel/copper/stainless steel construction.

In step 401, shown in FIG. 4A, a substantially planar sheet of stainless steel, preferably grade 304 alloy, 405 is drawn to form an fluid containing inner liner 410.

In step 402, shown in FIG. 4A, a substantially planar sheet of copper 415, or an alloy thereof is drawn to form a fluid containing vessel or middle shell 420.

In step 403, also shown in FIG. 4A, a substantially planar sheet of stainless steel 425, preferably grade 430 alloy, is drawn to form a fluid containing vessel or outer shell 430. Grade 430 stainless steel grade is preferred so that the completed article of cookware can be used for induction cooking.

In step 404, shown in FIG. 4B, the fluid containing inner liner 410 is nested within the middle shell 420. A brazing compound is applied to at least one of the exterior of the inner liner 410 or the interior of middle shell 420. Further, the middle shell 420, including inner line 410, is nested within outer shell 430, forming subassembly 445. Likewise, a brazing compound is applied to at least one of the exterior of the middle shell 420 and the interior of the outer shell 430.

It should be appreciated that each of the liner 410 and shells 420 and 430 are drawn in steps 401, 402 and 403 with sufficient dimension tolerances to facilitate complete insertion in the nested arrangement of subassembly 445, with a slight gap at each interface to accommodate the brazing compound and the eventual wicking of the molten brazing compound.

Also in step 404, to complete the brazing process, the temperature of the subassembly is raised to melt the brazing compound, which upon cooling forms a metallurgical bond at interfaces 454 and 455, substantially bonding each liner or shell to the next larger shell in subassembly 445. Liner 410 and shells 420 and 430 are also pressed together enabling the consolidation and flow of the liquid brazing compound at their respective common interfaces 454 and 455.

It should be appreciated that the liner 410 and shells 420 and 430 can be nested in an alternative sequence and be braised in multiple, rather than a single step, if desired. Preferably, the subsequent “ironing” process of step 406 of FIG. 4C is done after the bonding of the three liner/shells formed in steps 401, 402 and 403 by brazing in step 404. As described with respect to FIG. 2C, the “ironing process” not only reduces the copper thickness in sidewall 120, but also expels trapped air and moisture from interface 454 and 455.

As in forming cooking vessel 100 in FIG. 2, laser welding in step 407 is carried out after “ironing” in step 406, following by trimming to form rim 460, as indicated by the dotted line in FIG. 4D.

After trimming, the article of cookware is polished to the aesthetically desired final finish One or more side handle are generally attached after the trimming and polishing steps in the fabrication process.

It should be appreciated that alternatives to the embodiments described with respect to FIGS. 2 and 4 include substituting aluminum for copper. Further embodiments included a construction wherein a titanium, including alloys thereof, and aluminum or aluminum alloy preforms are bonded to each other. In such instances it would be preferable if the titanium or titanium alloy preform was used as the inner shell, with the aluminum or aluminum alloy preform as the outer shell. Such a bonded preform can be anodized by conventional processes after the bonding steps, thereby rendering the outer aluminum shell into the harder anodized aluminum, while providing a more chemically resistant titanium metal as the inner cooling surface.

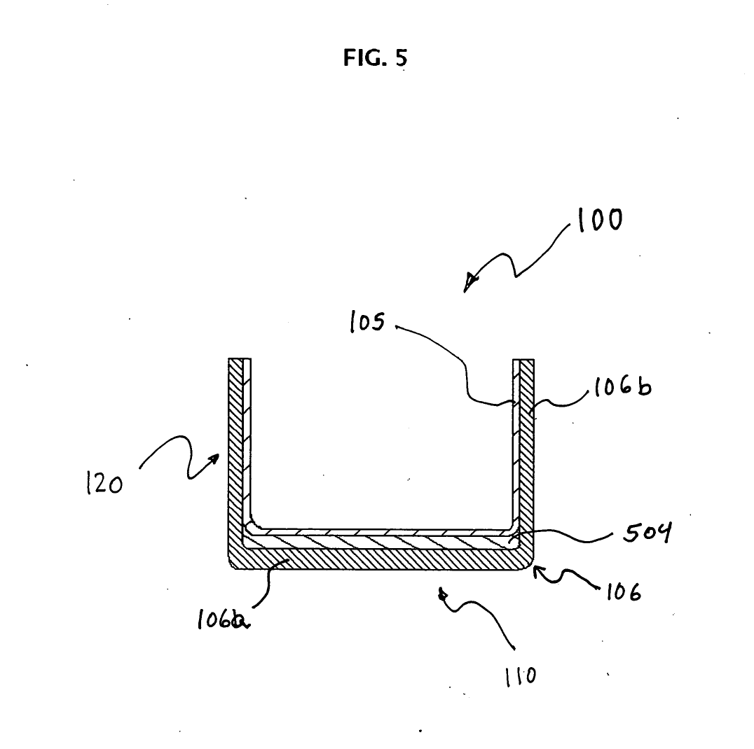

In accordance with another aspect of the present invention, FIG. 5 illustrates another embodiment of the invention in which an article of cookware 100 has a bottom cooking surface 110 surrounded by an upward extending sidewall 120 to form a fluid containing vessel. The sidewall and bottom have a laminated construction in which the entire inner cooking surface is lined with a layer of stainless steel 105 and the outside of the article of cookware is a copper cladding 106. At the bottom of the article of cookware 100 is disposed a layer of aluminum 504, or an alloy thereof, having a thickness of between about 2 mm to about 7 mm, disposed between the interior stainless steel lining 105 and the exterior copper cladding 106. As the aluminum layer 504 only extends across the bottom-cooking surface 110, the upward extending sidewall 112 comprises a laminate of copper 106b and stainless steel 105.

The above construction is highly advantageous as the aluminum layer 504, depending on the relative thickness with respect to the copper layer, helps to spread heat laterally. However, as the aluminum 504 is not disposed within the sidewall 112 of the cooking vessel, the lateral spread of heat is predominantly in the bottom of the cookware. Further, this construction avoids having to construct an article of cookware from an expensive triple laminated sheet of copper/aluminum/stainless steel.

The article of cookware 100 in FIG. 5 can be fabricated by impact bonding an aluminum slab or sheet that is pre-cut into a circle to one or both of the stainless steel or copper layers shown in FIG. 2. The step of impact bonding either can be carried out before or after the stainless steel or copper sheets are formed into vessels by the drawing process described in steps 201 and 202 of FIG. 2.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

1. A method of fabricating an article of cookware, the method comprising:
a) providing a first substantially planar sheet comprising at least one layer of a first metal,
b) providing a second substantially planar sheet comprising at least one layer of a second metal,
c) drawing the first planar sheet to form a first preform that is a fluid containing vessel,
d) drawing the second planar sheet to form a second preform that is a fluid containing vessel that nests within the first preform, each fluid containing vessel having a bottom surface and surrounding sidewalls extending upward therefrom,
e) nesting the second perform within the first perform to form a subassembly,
f) bonding the interface between the first and second perform to form a first bonded preform,
g) laser welding the first and second preforms together along an annulus that circumscribes the surrounding sidewalls at the portion thereof intended to form the rim of the article of cookware.

2. The method of claim 1 further comprising a step of ironing the first bonded preform such that the thickness in the surrounding wall portions of at least one of the first and second preforms is reduced in thickness to below the thickness in the bottom surface thereof.

3. The method of claim 1 wherein said step of bonding comprises brazing the first preform to the second preform.

4. The method of claim 3 wherein said step of brazing is performed before said step of ironing.

5. The method of claim 1 wherein said step of bonding further comprises bonding an aluminum layer between the first and second preform.

6. The method of claim 5 wherein said step of bonding the aluminum layer comprises impact bonding.

7. The method of claim 2 wherein said step of bonding comprises brazing the first preform to the second preform.

8. The method of claim 1 further comprising a step of trimming the first bonded preforms at the position of the laser weld to form the rim in the article of cookware.

9. The method of claim 1 further comprising the steps of:
a) providing a third substantially planar sheet comprising at least one layer of a third metal,
b) drawing the third planar sheet to form a third preform that is a fluid containing vessel that nests within at least one of the second and first preforms,
c) nesting the third perform within at least one of the first and second performs to form the subassembly,
d) bonding the interface between the third perform at least one of the first and second performs to form the first bonded preform,

10. The method of claim 9 wherein the third metal is the same as at least one of the first and second metal.

11. The method of claim 1 wherein at least one of the first and second preforms is fabricated from a copper sheet and the other preform is fabricated from a metal selected from the group consisting of stainless steel, aluminum, aluminum alloys, titanium and titanium alloys.

12. The method of claim 1 wherein at least one of the first and second preform is fabricated from an aluminum sheet and the other preform is fabricated from a metal selected from the group consisting of stainless steel, titanium and titanium alloys

13. The method of claim 1 wherein at least one of the first and second metal sheets comprises two or more layers of different metal and alloys.

14. The method of claim 10 wherein the first metal is stainless steel and the second metal is copper or an alloy thereof.

15. The method of claim 10 wherein the first metal is stainless steel and the second metal is aluminum or an alloy thereof.

16. The method of claim 10 wherein at least one of the first, second and third metals is titanium and at least one of the other two metal is aluminum or an alloy of aluminium.

17. The method of claim 16 further comprising the step of anodizing the aluminum layer of the cooking vessel.
